(19) United States
(12) Patent Application Publication
(10) Pub. No.: US 2007/0063082 A1
(43) Pub. Date: Mar. 22, 2007

(54) Method, device, system, and program for the implementation of shredding

(76) Inventor: Brian Bernard Coleman, Washington, DC (US)

Correspondence Address: BRIAN B. COLEMAN, 1414 10TH STREET NW, WASHINGTON, DC, 20001, US

(21) Appl. No.: 11/229,211

(22) Filed: Sep. 19, 2005

(51) Int. Cl. B02B 5/02

(52) U.S. Cl. 241/101.2; 705/1

(57) ABSTRACT

A shredding device, method, system, and software program for the destruction or obliteration of confidential information. The invention may have the ability to shred by a unit of measurement. The device being a self-service bulk shredder that charges the user by a unit of measurement, such as: weight, time, or number of various item types or pages. These items types may be sorted and logged by units. In addition, the size of the shredding maybe selected. The unit information may be used to determine a cost and usage data for operational and management purposes. A user may place bulk items in the shredder to be weighed to assess a cost and display cost and payment information to a user. Payments may be made electronically and/or by cash. The device can produce an itemized receipt and/or a Certificate of Destruction, which may be provided electronically and/or emailed.

### COPYRIGHT STATEMENT

The portion of the disclosure of this patent document contains material, which is subject to copyright protection. The copyright owner has no objection to the facsimile reproduction by any of the patent document or the patent disclosure, as it appears in the Patent and Trademark Office patent file or records, but otherwise reserves all copyright rights whatsoever.

### BACKGROUND OF INVENTION

This invention relates to the bulk shredding of documents, credit cards and other data storage materials by the average consumer in the home or small business. Hereinafter the small business or home user will be referred to as the consumer, but not limited to, but also to include any user, including lawyers, doctors, government workers, artists and authors and other professionals.

The use of shredders today by the consumer is typically done in the home or small office. Therefore, the shredders commonly used are limited by types of shredding but also limited by capacity and types of material that can be shredded.

The shredders commonly used produce either straight or cross sectional cuts, which do not provide the level of destruction, security or secrecy necessary for protecting, confidential medical information or personal and business financial information in today's environment of identity theft and misuse of personal information.

The shredders used by these consumers are also limited by their capacity to handle large volumes of materials. Typically these shredders can only handle single, individually fed items, but generally no more than 20 sheets of paper at one time. Any attempts at large capacity shredding may result in device malfunction.

Another draw back is the limitation to the types of materials that can be shredded in the devices currently being used. These shredders are single use devices used for either destroying paper documents or plastic documents such as credit cards or compact discs (CD's).

These drawbacks in terms of types of shredding and limitations with capacity and limitations on types of materials that may be shredded are not as great a problem as the concern for convenience and expense of the shredding process.

Today, in order to do bulk shredding you have to purchase and expensive bulk shredder or contract these services out to a bulk shredder service company. Bulk shredders are cost prohibitive for the average consumer or small business.

The consumer would have to purchase an expensive bulk shredder or contract these services to a bulk shredding company. But bulk shredding is cost prohibitive for the consumer or small business because these devices are too expensive to purchase and maintain; and therefore, it is not a feasible proposition. Moreover, consumers often go through periods or cycles when bulk shredding is greatly needed. Other times the need may only be for limited quantities to be shredded, making the purchase of bulk shredders infeasible. In addition, bulk shredders are large items, which take up a great amount of space, makes lots of noise and creates enormous amount of waste product.

In order to reduce or limit this expense, need for maintenance, lack of space (special constraints), need for outside third party contracting: a bulk shredder, unlike one that currently exists today, which optionally provides the consumer with levels of destruction or obliteration, through a service charged by time and/or capacity built within one unit, would provided a different and new option.

Summarily there are no shredders today that do bulk shredding that charge either by the capacity, time or level of shredding built into one unit, that allows a consumer to conveniently take his/her bulk shredding to a location, shred the materials themselves and be charged for the shredding by a self contained shredder.

### SUMMARY OF INVENTION

A feature of the present invention is to provide a novel method, device, system, and software program for shredding documents and materials conveniently, inexpensively, with greater security and with a greater capacity of shredding materials. To solve this problem of limited capacity for the average consumer, a self-contained device, which charges the consumer by the amount of material to be shredded, is a feature of one embodiment of the invention.

Another feature of the present invention is to provide a novel method, device, system, and software program for shredding documents and materials conveniently, inexpensively, with greater security and with the flexibility of charging the consumer for the amount of time to shred the material; thereby, reducing cost by only the amount of equipment time being used. By only using the amount of time actually used for shredding provides more efficient cost calculations.

Another feature of the present invention is to provide a novel method, device, system, and software program for shredding documents and materials conveniently, inexpensively, with greater security and with the flexibility of choosing the levels of shredding to ensure security combined with the option of selecting any of the previous embodiments.

Still another feature of the present invention is to provide a novel method, device, system, and software program for shredding documents and materials conveniently, inexpensively, with greater security and which combines the previous embodiments into one device.

In addition to the disclosed steps in the detailed description below, the method may also comprise any combination of the following steps: Step of selecting the method of payment; Step of verifying the receipt of payment; Step of over-riding payment for employee or special situations. Step of verifying the identity of the user, Step of logging into the computer system; Step of saving user information to be retrieved to verify or bill a user; Step of placing items into the hopper (01); Step of placing individual or small number of items in the smaller slot (02); Step of items being weighed; Step of recording the weight of the items weighed; Step of selecting the type of cut; Step of selecting the level of security; Step of shredding the material; Step of sorting the material; Step of being alerted when the bins being filled with shredded material reach a particular level so that they may be emptied; Step of counting the items or number of pages to be shred; Step of printing or displaying a receipt; Step of printing or displaying a certificate of destruction; Step of inputting an amount of time to shred; Step of inputting an amount of weight of items to be shred; Step of calculating the amount of weight; Step of calculating the amount to be charged; Step of calculating the amount of cost based on type or shredding or level of security; Step of inputting the signature to verify a user, sign a receipt or document of destruction; Step of emailing a receipt, invoice, certificate of destruction, or a statistical report; Step of providing a receipt, invoice, certificate of destruction, or a statistical report to be printed, displayed, or electronically stored.

Step of displaying and/or printing a coupon; Step of displaying and/or printing an advertisement and/or Step of storing information electronically.

In addition to the disclosed devices in the detailed description below, the devices may also comprise any combination of the following items: Shredder; computer, software storage; scale for weighing; item sorter; biometric device; camera; server; item counting device; time calculating device; touch screen device; printer; wireless; network; input/output device; cutting device; pointing device; stylus; electronic pen; hole-punch; rolling wheels; paper feeder; browsing device; remote control; infrared device; switching device; signal transmitter/receiver; and/or screen.

Other features and advantages of the invention will be apparent upon reading the following detailed description of preferred embodiments of the invention in conjunction with the accompanying drawings.

### BRIEF DESCRIPTION OF DRAWINGS

The accompanying drawings, which are incorporated in and form a part of the specification, illustrate embodiments of the present invention together with the description; explain the principles of the invention. In the drawings:

FIG. 1 is view of the combined embodiment of the present invention.

FIG. 1A is a top perspective view of the shredder of FIG. 1.

FIG. 1B is a separate view of the apparatus for shredding smaller or individual items.

FIG. 2 is the level of security selection screen.

FIG. 3 is the shred by weight, time, or number of items/pages selection screen.

FIG. 3A is the shred by weight screen.

FIG. 3B is the shred by time screen.

FIG. 3B1 shred by time: actual shredding time.

FIG. 3C is the select shredding time.

FIG. 3C1 is the shred by number of items/pages screen.

FIG. 3C2 is the shred by number of items/pages input by user screen.

FIG. 3C3 is the shred by actual number of items/pages screen.

FIG. 4 is the shredding complete and total cost screen.

FIG. 4A is the shredding complete: certificate of destruction and receipt screen.

FIG. 4B is a sample certificate of destruction.

FIG. 5 is the method of payment screen.

FIG. 6 is a diagram of different possible network connections of the invention

FIG. 7 is sample report of shredding usage.

### DETAILED DESCRIPTION

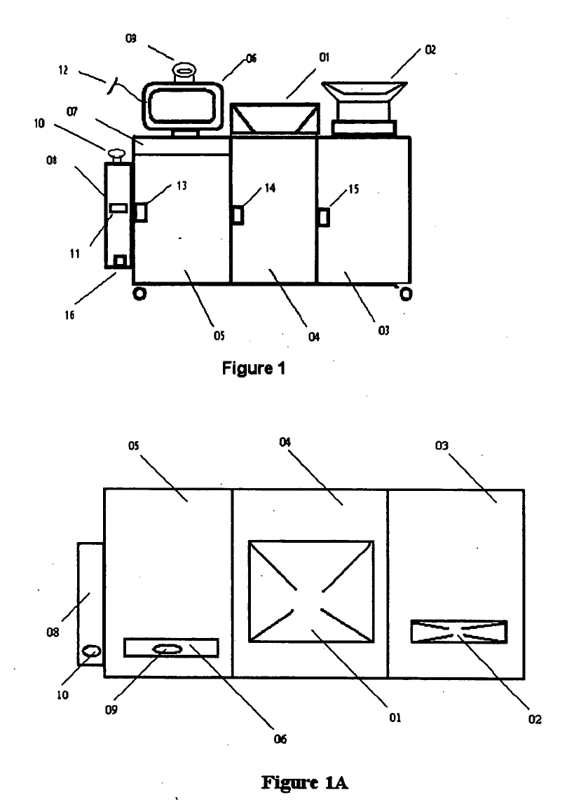

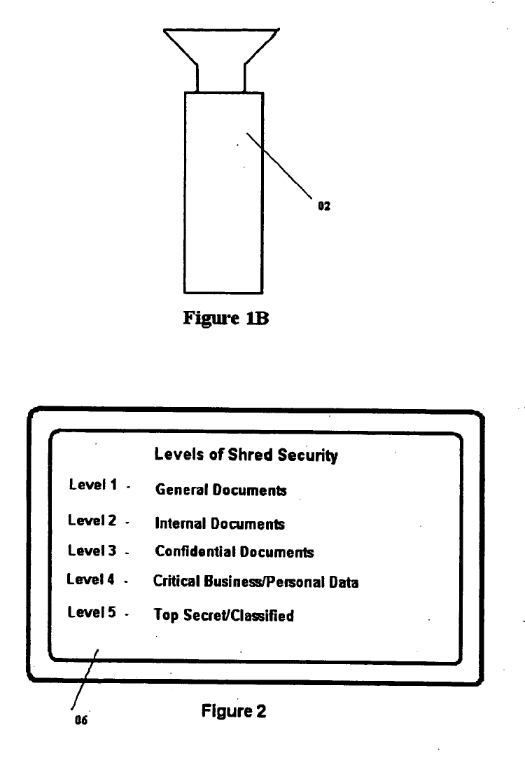

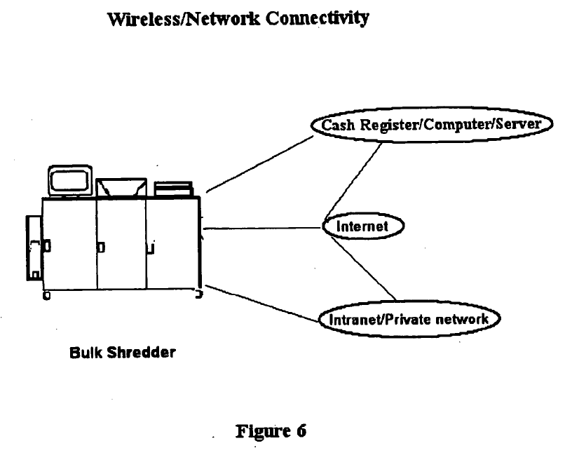

FIG. 1 illustrates a bulk-shredding machine (01), with a computer screen (06). The computer screen (06) may have an input/output user interface such as a touch screen and/or optionally a computer keyboard, pointing device, such as a mouse, microphone, or electronic writing/signature device (12). Wherein a computer (07) or a computer system consists of any combination of the following: a CPU, co-processor, a printing device, Internet and network access, memory storage, cache, compact disc (CD), Digital Video Disc (DVD), software, EPROM, RAM (random access memory), Universal Serial Bus (USB) ports, USB drive, removable drive/media, serial, Ethernet, optical and wireless connectivity (I.E., wireless fidelity (WIFI), Blue Tooth, etc.), speakers, camera (09), character recognition, voice recognition, text-to-speech, speech-to-text, client/server capable, e-mail, phone, facsimile, biometric input/output (10), weighing scale, item sorter, timer/clock, calendar, scheduler, calculator, security encryption, barcode reader, cables, browser, operating system or other items normally associated with a computer (07). The computer (07) is optionally stand alone, networked, a client, or server. The user interface programmed to respond to user input, which will provide the steps to activate the shredder and charge based on data input. One unique feature of this embodiment involves a shredding means, which may optionally be connected to provide a step to provide transactional and statistical information to cash register/computer/server (61), the Internet (62), intranet/private network (63), over a wireless/network (FIG. 6), a computer (07), and electronic storage or data storage. The computer (07) is optionally be programmed to provide a step to advertise in general, as well as, advertise the features of the invention via e-mail, printed items (I.E., receipt, coupons, etc.), or the computer screen (03). These items all comprise separate means involved in the embodiment of the invention which maybe be used in various combinations including pluralities of the items above. The computer screen (06) having a means for entering data in a data entering step via the means such as a touch screen or other data entry device, which is able to capture entries or the keyboard or other devices listed above in a data capturing step.

Also illustrated in FIG. 1 are collection bins (03, 04, 05) for sorting and recycling various shredded materials having a means for sorting, such as that disclosed by U.S. Pat. No. 4,096,949, inventor Hoover et al., issued Jun. 27, 1978, hereby incorporated by reference in it entirety. Items (13, 14, and 15) illustrate handles for accessing individual collection bins (07, 09 and 11). The bins (03, 04, 05) also enclose the shredding units such as that disclosed by U.S. Patent Application Publication No: US 2003/0006330 A1, inventor Frank Chang, issued Jan. 9, 2002, hereby incorporated by reference in its entirety and also disclosed by Herbst, et. al., U.S. Pat. No. 5,071,080, issued Dec. 10, 1991, hereby incorporated by reference in its entirety. A document shredding means such as a device having the ability to provide the steps to cut documents into strips and chip cutters are disclosed by U.S. Pat. No. 4,192,467, by inventor Hatanaka, issued Mar. 11, 1980, hereby incorporated by reference in its entirety. FIG. 1A is a top view of FIG. 1.

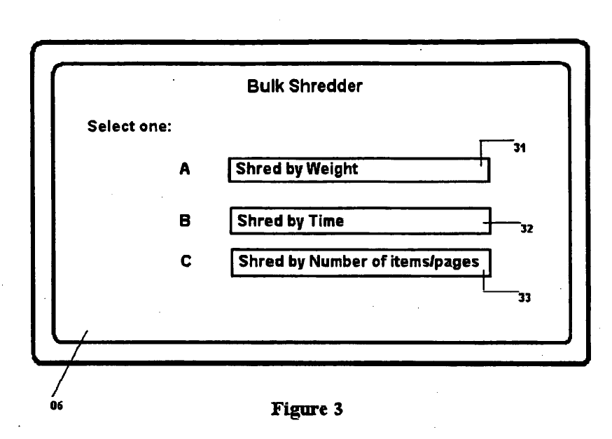

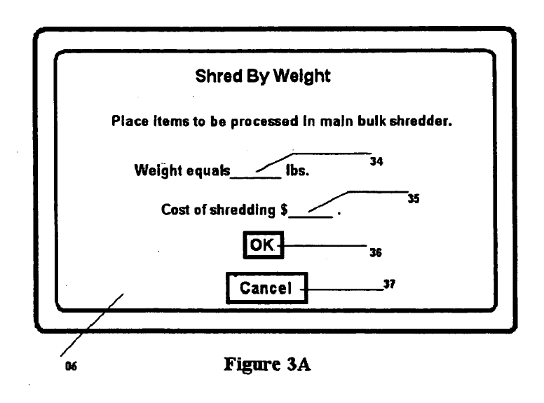

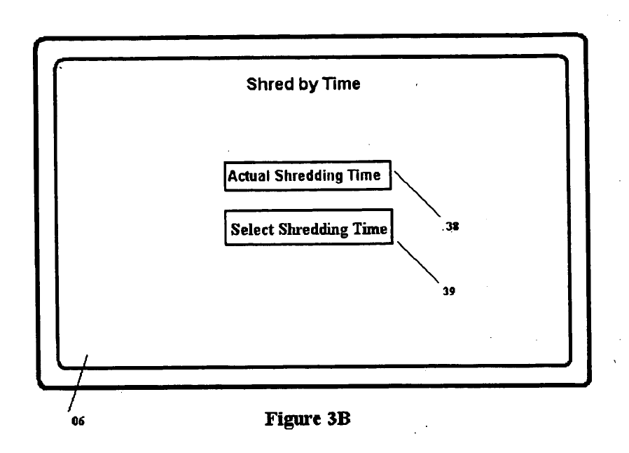

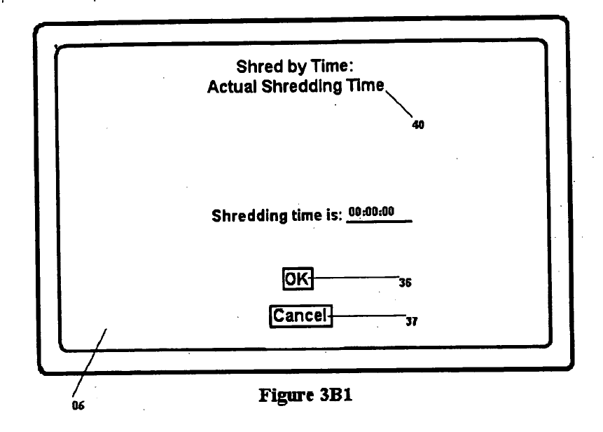

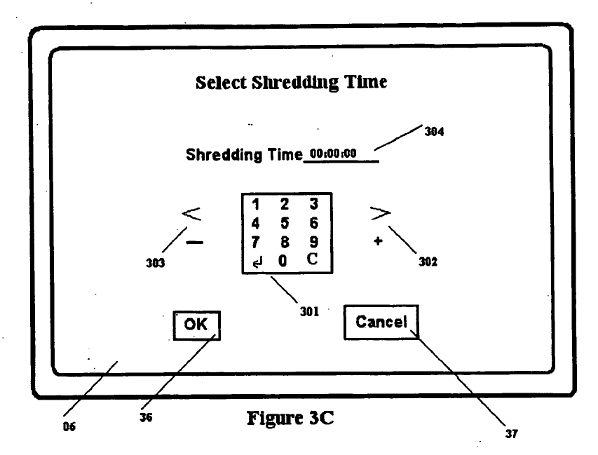

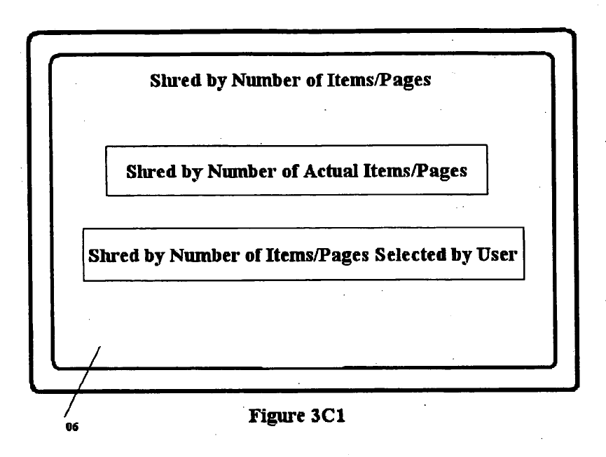

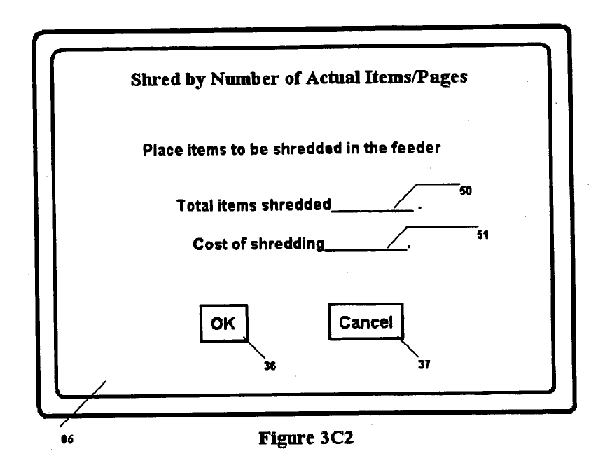

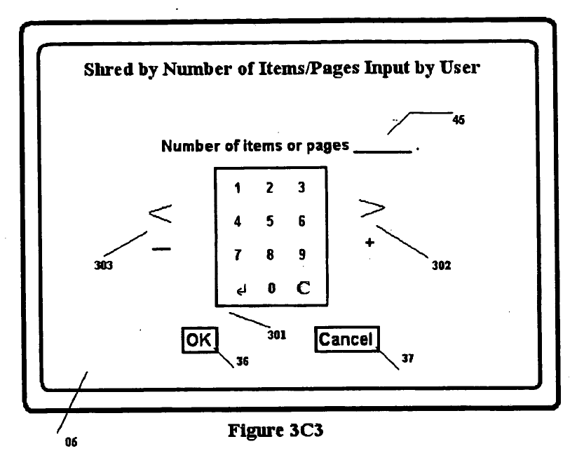

Another embodiment involves a means for shredding individual items or a small number of items (FIG. 1B). A slot in item (02) provides a step that allows items to be placed or fed so that items are shredded individually or a smaller number of items than would normally be shred in the main hopper (01). The hopper (01) is optionally provided with steps to shred items individually and/or a small number of items. FIG. 1B, item (02), optionally has the ability to count the number of items shredded using a counting step or the user optionally will be asked to provide a number of items to be shred as in FIGS. 3C1, 3C2, and 3C3 in a user input step.

One feature of an embodiment involves means of selection using a software interface programmed to enable the shredding to provide one of five security levels by the user (FIG. 2), thereby providing a device, system, program, and method of use. The levels of security complying with the DIN32757 (or any modification thereof or any other document destruction standard) standard or other standard to include DOD (Dept. of Defense) document destruction standards, to assist users with classifying documents. See Table 1 below for different levels of security that comply with the DIN32757 standard.

TABLE 1

| | | Maximum Strip | |
|---|---|---|---|
| Level | Description | Width | |
| 1 | General paperwork, old documents | 12 | mm |
| 2 | Internal documents, print outs, drafts | 6 | mm |
| 3 | Confidential documents | 2 | mm |
| 4 | Critical business and personal data | 2 × 15 | mm |
| 5 | Top secret or classified documents | 0.8 × 12 | mm |

Another embodiment involves a means for charging wherein the user interface being programmed to provide a step to enable the user to select the option of selecting the security level using a security level selection step optionally affects the amount charged. For example, level 1 is charged at a rate of X1, level 2 at a rate of X2, level 3 at a rate of X3, and so on, wherein X represents a unit amount such as dollars/cents (currency) or credits.

Another embodiment involves a means for charging wherein the user interface being programmed to provide a step to enable the user to select the option of the type of cut using a cut selection step optionally affects the amount charged. The types of cuts to include but not limited to, strip-cut, straight-cut, cross-cut, confetti-cut, hole-punch-cut, tear, grind, slice, chop, pulverize, or other type of cut used in paper, item, or material destruction. For example, a cross-cut is charged at a rate of X1, straight-cut at a rate of X2, a confetti-cut at a rate of X3, and so on, wherein X represents a unit amount such as dollars/cents (currency) or credits.

Another feature of the embodiment involves a means for selection by weight (FIG. 3, item 31). The user interface being programmed to provide a step to enable the user to select the option of being charged by the weight (31) of the materials to be shredded, thereby providing a device, system, program, and method of use. The step of placing items into the feed hopper (01) to be weighed using a means for weighing such as a scale, electronic scale or other such device and the step of calculating using a calculating means, such as, a calculator, computer, or other such calculating device, based on the weight calculation (34), to provide the step of determining the cost of shredding (35). Optionally, providing a step wherein the items maybe weighed using a separate weighing scale and providing a step wherein the weight is optionally entered manually into the computer interface screen (06). While the hopper (01) optionally includes a means for weighing; the hopper (01) may alternatively not include a means for weighing. Wherein, the means for weighing is optionally separated from the hopper (01) or slot (02). Providing the user with a step of accepting (36) or canceling (37) the operation by using the interface means as described in FIG. 3A

Another feature of the embodiment involves a means for selection by time (FIG. 3, item 32). The user interface being programmed to provide steps to enable the user to select the option of being charged by the amount of time the user desires or needs in estimating time of shredding (FIG. 3B), thereby providing a device, system, program, and method of use. Using a means for calculating time, such as, a timer, clock, computer, or other such time device, the user may be provided a step of having an option of having the programmed computer software to determine the amount of time used during an actual shredding cycle (38) or providing a step to the user of inputting a specific amount of time (39) into the user interface. The user optionally has a step of entering an exact amount using the programmed user interface (301), which can be increased (302) or decreased (303); alternately a step of providing a default time may be programmed, which is optionally increased (302) or decreased (303). Providing a step wherein the cost of shredding as a function of time is optionally displayed (FIG. 3A, 35), printed, or saved electronically along with the shredding time (FIG. 3C, 304).

Another embodiment involves a means for shredding a number of items or pages (FIG. 3, item 33). The user interface being programmed to provide a step to enable the user to select the option of shredding by number of items or pages (FIG. 3C1), thereby providing a device, system, program, and method of use. The computer software providing a step to the user with the option of selecting shredding by the actual number of items or pages, or providing the step to the user with the option of selecting a number of items or pages to be shredded wherein the number of pages or items are optionally counted in a counting step using a counting means, such as an automatic counter, sensor, light emitting diode counter, or other similar item counter. A means for automatically starting or stopping the step of the engaging of the shredding means such as a sensor like a light emitting diode or infrared sender/receiver used to detect when the hopper (01) or slot (02) is empty causing the shredding means to automatically stop and the computer software to go back to the initial setting to await operation by a user, screen saver mode, or and advertising mode. The automatic starting/stopping means and steps to be used with the other embodiments including starting and stopping the timing means or time calculating step, or when to begin and stop weighing, such as when the scale or hopper (01) is empty to stop or full to begin conditionally on ability to pay or over-ride as determined in the payment means. A means to detect jams by detecting when the feeding means using the automatic starting/stopping means jerks or miss-feds causing a reverse mode to activate using a reversing means wherein the gears move in the reverse direction for a few seconds to free up the feeding means such as the cutting gears and then may optionally proceed in the normal forward direction or stop. An example of a counting step for how pages are counted using a counting means to be shred is disclosed by U.S. Pat. No. 5,354,001, inventor Hasegawa, issued Oct. 11, 1994, hereby incorporated by reference in its entirety. Also anticipated is using a charging means to charge for shredding using a shredding means wherein a user can be charged to shred an amount that fills a container means, such as a box, bag, tray, or hopper (01), or the like to a certain level or per container type or size optionally using any of the means or steps described herein.

Another embodiment involves means for selecting the option of copying an image of each item/page before the items/pages are destroyed using an image copying means such as a camera, scanner, copier, facsimile or other such image capturing device. The user interface being programmed to provide the step to enable the user to select the option of copying an image(s) of the items to be shredded and be charged for copying the images and/or shredding, thereby providing a device, system, program, and method of use. The computer software providing a step to the user with the option of saving individual images of individual individual items/pages or all images each of which are optionally stored in a storage object such as a database, file, folder, directory, collection of bits or data, or any other grouping of information. The computer software programmed to further provide the step of allowing the user to choose to save a copy on a storage means, such as, a DVD, CD, electronic storage device, disk, or removable media, which are optionally transmitted electronically to a remote device. The computer software programmed to provide the step of charging an amount to the user for copying images to be shred using charging or payment means, such as, credit card machine, register (61), phone billing, check reading/processing PayPal, smart card, cash, tokens, debit, Speedpass or like device, or bio-chip, such as a, MONDEX bio-chip, passport bio-chip or other such payment devices. The cost charged are also optionally a function of other options used in the other embodiments as each other embodiment could charge a cost separately for each option selected. Hasegawa, U.S. Pat. No. 5,354,001, which was incorporated by reference previously, discloses copying pages before being shred.

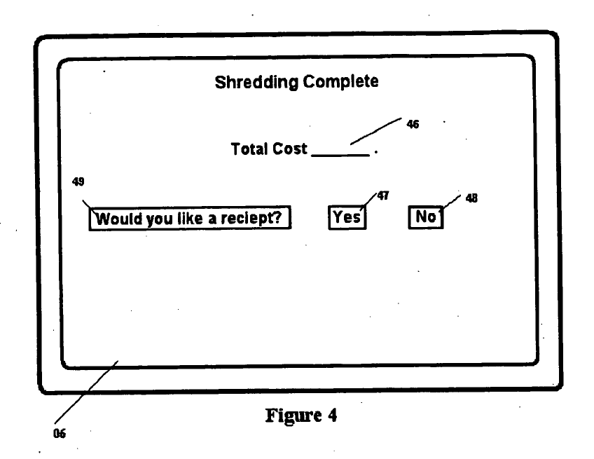

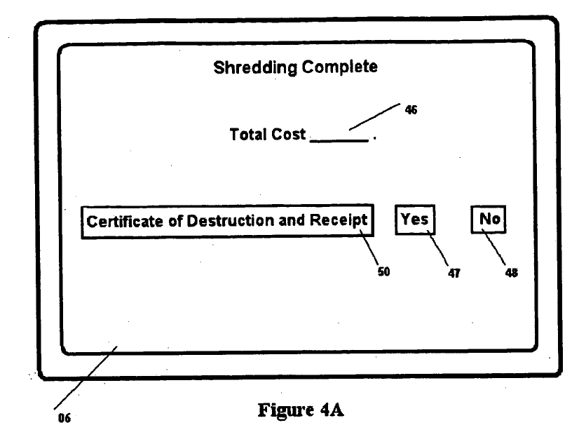

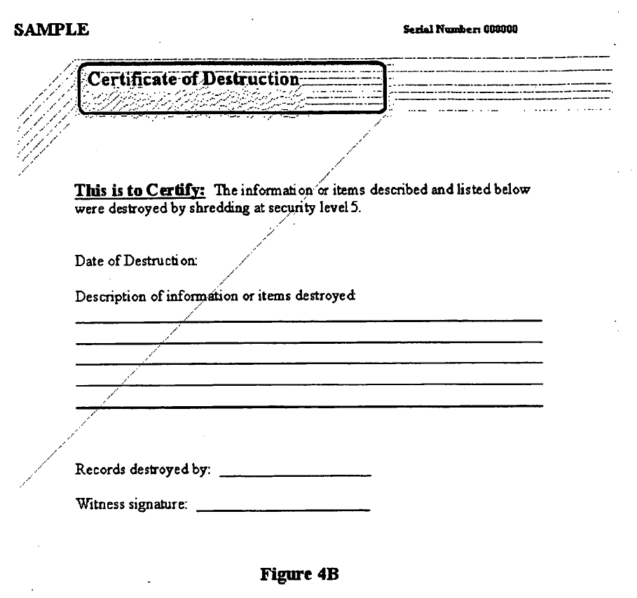

Another embodiment involves a means for providing a receipt and or Certificate of Destruction wherein FIG. 4B is a sample of such a certificate. The user interface being programmed to provide a step to enable the user to select the option of providing a receipt and/or a Certificate of Destruction via a printing means, such as, a printer or other such printing device, electronic means such as email or display, thereby providing a device, system, program, and method of use. A receipt may include the cost of the service and/or the transactional information. Providing a step to enable the user to choose the receipt only item and the user would make that selection on the user interface (FIGS. 4, 49). Alternately, providing a step to the user with the option of choosing a receipt and/or certificate of destruction (50). The Certificate of Destruction (FIG. 4B) may include all or any of, but not limited to: method of destruction, date, time, city, state, seal, logo, weight of items shredded, amount of shredding time, address, space for authorization signature, destroyed by signature or witness signature, total cost, method of payment, other payment information, description of items destroyed, level of destruction, type of shred (cut) used, whether images of items destroyed were captured or other such pertinent information. The signature(s) and other information may be captured using an electronic/signature means such as an electronic pen (12) or other such electronic/signature capturing device, in an electronic/signature capture step. The computer screen (06) having a means for providing a step of entering data via the means such as a touch screen or other such device able to capture entries, signatures, and a step of providing verification of the data. A photograph or image capture means such as a camera (09) or other image capture means such as stated elsewhere in the specification, to provide the step of taking a picture or a biometric means such as a fingerprinting device (10), or other such biometric device such as stated elsewhere in the specification, providing a biometric capture verification step that is optionally used with the printing means to provide the step of printing a picture or a fingerprint on the receipt or Certificate of Destruction (FIG. 4B) or the photograph means or biometric means optionally used to overlay an image over the receipt or Certificate of Destruction (FIG. 4B) with an overlay step to be emailed using a means for emailing, such as an email program, gateway, server or other such email device, in a step of emailing. The receipt/invoice may also contain items listed on the Certificate of Destruction (FIG. 4B).

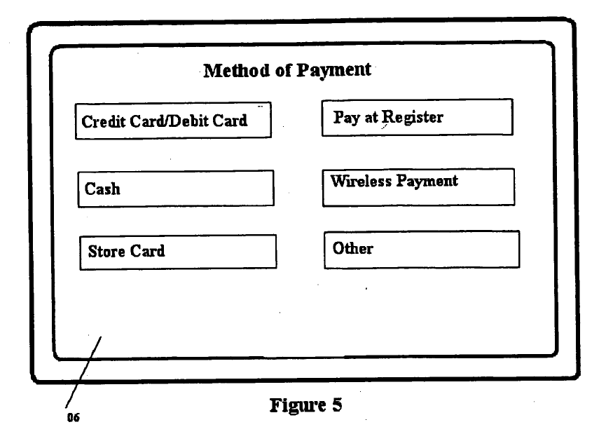

Another embodiment involves a means of selecting payment involving a method, device, system, or computer program. The user interface being programmed to provide a step to enable the user to select the method of payment (FIG. 5) and provide a step to charge the user via a charging or payment means, thereby providing a device, system, program, and method of use. The user is optionally provided a step of making a selection on the computer interface for a card means such as a credit/debit, cash/token, store card, gift card, or cash to pay at the cash register (61) wherein the cash register (61) takes all forms of payment using standard payment systems. Providing a step to the user with the option of choosing a credit/debit option, a step of instructing the user to insert credit or debit card into the onboard credit/debit machine (08) for payment, which will be processed in a processing step by standard payment means which verifies the payment in a payment verification step. The change dispenser means (16) for receiving change in a receiving change step. Providing a step to enable the user to select the option of inserting standard currency or tokens into the cash/token reader (11). Providing a step to enable an employee to over-ride charging means or the charging step. Providing a step to enable the user to choose to pay at the register (61), then the total cost of services will be transferred to a register (61) in a transferring step where the user optionally completes a final payment transaction step. Other optional steps may include, but not limited to, payment through a wireless provider (I.E., wireless phone carrier, etc.), smart card, other mechanisms such as Blue Tooth (or the like) or biometric devices such as fingerprint identification, ear print, voice print, ear print, facial recognition, handwriting recognition, or eye retina identification pay systems. An illustration of facial recognition using an image capture means is disclosed by U.S. Pat. No. 6,137,896, inventor Chang et al., issued Oct. 24, 2000, hereby incorporated by reference in its entirety. An illustration of biometric identification using eye retina or iris detection is disclosed by U.S. Pat. No. 6,119,096, inventor Mann et al., issued Sep. 12, 2000, hereby incorporated by reference in its entirety. Another illustration of a biometric device and use, along with remotely updating software on a computer, collecting data from a user through a computer interface, generating reports, programming and scripts, distributed network connections, and authorization to access a network is disclosed by U.S. Patent Publication No. 2003/0229514 A2, inventor Brown, republished Dec. 11, 2003, hereby incorporated by reference in its entirety. In addition to locally updating the programming software, a means for updating the software programs on the computer (07) remotely, such as remote version updating software, or other such updating device, or other such updating device such that the computer (07) are optionally maintenanced and updated remotely over the Internet or network including wireless means.

A user could be provided a step of logging into the computer (07) using an identification name and password, credit card, I.D. card, or any payment options and be billed with saved information using a billing step and information retrieved using a user information retrieval step. Providing a step wherein the user is optionally allowed to run a tab to be billed later or immediately. The information and data to be stored in storage means such as database or spreadsheet on a computer using an information storing step.

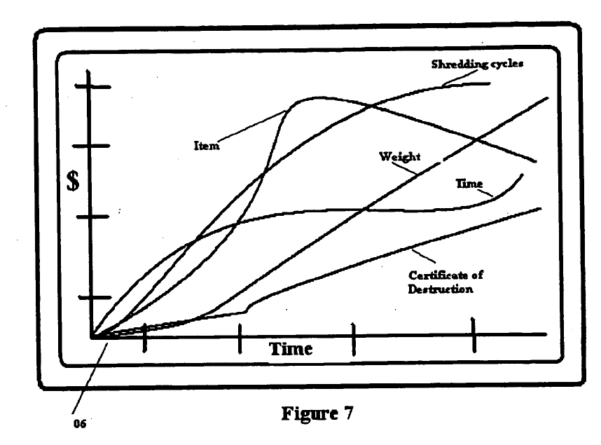

Another embodiment involves means for providing statistical information (FIG. 7) related to operational use of the shredder payment involving a method, device, system, or computer program. The computers programming will provide a step to calculate statistical data, which may include totals for different units of time, weight, periods of time, numbers of various types of items shredded, costs, shredding cycles, maintenance and usage information, thereby providing a device and method of use. Information may be included in reports, which maybe displayed using a displaying step, electronically sent over a network to a computer or electronic storage using an electronic sending step, wherein a step of providing reports which may include text, graphs, tables and charts (see FIG. 7) and maybe stored in a database or spreadsheet on a computer using a data storing step. The information is optionally stored in a data storing step electronically using a storage means, printed using a printing means in a printing step, and/or displayed using a display means, such a computer screen (06) or other similar type of display device, using a data displaying step and include user identification, billing and usage information. Certificates of Destruction (FIG. 4B) may also be tracked using a tracking step and stored, displayed, or printing using corresponding steps. This information may also be useful in determining shredding cycles.

Other embodiments include combination of the stated embodiments in every combination possible including a plurality of shredders, computers, screens, slots, peripheral devices, and other devices as listed above. Also contemplated are that the software programming may be embodied on a computer based medium, carrier wave, storage device, disk or chip. The information is optionally stored in a database, file or other data structure optionally with sorting and pointers. The data is optionally grouped into categories. The methods disclosed are optionally deemed methods of doing business. The embodiments are optionally controlled remotely such as when a user can pay at the cash register (61) for time, and/or weight, possibly weighed separately and credited with use at the shredder to shred items.

I hereby claim:

1. A method of using a computer to perform operations of using a shredder to shred items comprising:
charging a payment for using the shredder by a user.

2. The method of claim 1,
activating the shredder to shred items after acknowledging receipt of payment.

3. The method of claim 1,
charging for payment based on one or more of a number of items, weight, time, actual shredding time, amount that fills a container, a certain level of a container, or until the feed hopper is empty.

4. The method of claim 1,
counting the number of items to be shred.

5. The method of claim 1,
selecting the option to copy an image of each item to be shredded.

6. The method of claim 1,
providing an option of a receipt.

7. The method of claim 1,
providing an option of a certificate of destruction.

8. The method of claim 1,
providing an option of one or more of printing or displaying dat

9. The method of claim 1,
logging into the computer.

10. The method of claim 1,
providing an option of selecting a type of cut.

11. A device using a computer to perform operations of using a shredder to shred items comprising:
means for charging a payment for using the shredder by a user.

12. The device of claim 11,
means for activating the shredder to shred items after acknowledging receipt of payment.

13. The device of claim 11,
means for charging for payment based on one or more of a number of items, weight, time, actual shredding time, amount that fills a container, a certain level of a container, or until the feed hopper is empty.

14. The device of claim 11,
means for counting the number of items to be shred.

15. The device of claim 11,
means for selecting the option to copy an image of each item to be shredded.

16. The device of claim 11,
means for providing an option of a receipt.

17. The device of claim 11,
means for providing an option of a certificate of destruction.

18. The device of claim 11,
means for providing an option of one or more of printing or displaying data.

19. The device of claim 11,
means for logging into the computer.

20. The device of claim 11,
means for providing an option of selecting a type of cut.
